(19) United States
(12) Patent Application Publication
(10) Pub. No.: US 2002/0096511 A1
(43) Pub. Date: Jul. 25, 2002

(54) Temperature control apparatus for electric heating equipment

(76) Inventors: Mitsuru Tsumanuma, Kamikawa-Gun (JP); Kikuji Takahashi, Asahikawa-Shi (JP); Tadatoshi Matsuyama, Tochigi-Ken (JP)

Correspondence Address: ISRAEL GOPSTEIN, Esq., Suite 200C, 14301 Layhill Rd., Silver Spring, MD, 20916-9303, US

(21) Appl. No.: 09/945,824

(22) Filed: Sep. 5, 2001

(30) Foreign Application Priority Data
Jan. 19, 2001 (JP) 2001-11158

(51) Int. Cl. H05B 1/02

(52) U.S. Cl. 219/501; 219/497

(57) ABSTRACT

A temperature control apparatus for electric heating equipment which can keep the temperature of the load of various heating equipment in substantially constant, and the electric power for heating consumed in vein can be eliminated to save the energy therefor.

The apparatus of the present invention for electric heating equipment comprising: a SSR 5 included in an AC line 4 connected between an AC power supply 2 and the electric heating equipment 3; and a CPU 6 for outputting control signals to the SSR 5 for switching the relay, wherein the SSR 5 continuously outputs an input AC voltage fed from said AC power supply, or alternatively outputs the input AC voltage intermittently by cutting one cycle of waveform from the waveform of the input AC voltage, and wherein the temperature control of the electric heating equipment 3 is effected by controlling the apparent frequency of the input AC voltage to be supplied to the electric heating equipment through adjusting the interval of the waveform.

### BACKGROUND OF THE INVENTION

1. Technical Field

The present invention relates to a temperature control apparatus for an electric heating equipment such as the road heating equipment, the floor heating equipment, or the water heating equipment.

2. Description of the Prior Art

In the electric heating equipment including an electric heater such as the road heating for melting snow deposited thereon, the floor heating for housing, or the electric water heater, the temperature control have been effected through so called ON-OFF control of the supplied power on the basis of the temperature of the load to be heated.

In the case of the heating equipment of the prior art, the temperature of the load to be heated increases as the power to be supplied is set to the “ON” condition. When the temperature of the load reached a predetermined upper limit, the power is set to “OFF” condition, and then the temperature of the load decreased to the lower limit, and the power is set again to “ON” condition to keep the temperature of the load substantially constant.

In other words, in the control apparatus of the prior art, the temperature of the load to be heated varies between the upper and lower limits, since the electric power to be supplied to the load have been controlled merely by ON-OFF action.

Provided that the width of the range of the variation of the temperature between the upper and lower limits is relatively narrow, the frequency of the ON-OFF action will increase. This will also be a cause of the shortage of the electric heating equipment.

In this connection, the width of the range cannot be narrowed even in the case that the load is relatively low. It is therefore necessary to set the upper limit higher than that necessary. This will lead to the wasteful consumption of the electric power.

Accordingly the object of the present invention is to provide a temperature control apparatus for an electric heating equipment which can keep the temperature of the load of various electric heating equipment in substantially constant, and the waste of power is hard to be resulted and can save energy.

### SUMMARY OF THE INVENTION

These and other objects are achieved by a temperature control apparatus for an electric heating equipment in accordance with claim 1 of the present invention comprising:

a solid state relay included in an AC line connected between an AC power supply and the electric heating equipment; and

a central processing unit for outputting control signals to the solid state relay for switching the relay, wherein the solid state relay continuously outputs an input AC voltage fed from said AC power supply, or alternatively outputs the input AC voltage intermittently by cutting one cycle of waveform from the waveform of the input AC voltage, and wherein the temperature control of the electric heating equipment is effected by controlling the apparent frequency of the input AC voltage to be supplied to the electric heating equipment through adjusting the interval of the waveform.

The temperature control apparatus for an electric heating equipment in accordance with claim 2 of the present invention comprising:

a solid state relay included in an AC line connected between an AC power supply and the electric heating equipment; and

a central processing unit to which connected a temperature signal line from a temperature sensor or sensors arranged over the electric heating equipment, said central processing unit outputs control signals to the solid state relay for the switching operation of the solid state relay on the basis of the temperature of a load of the electric heating equipment detected by the temperature sensor, wherein provided that the difference between the temperature of the load and that set on the central processing unit is substantially, said solid state relay outputs an AC voltage identical in its waveform with that fed from said AC power supply, whereas upon reduced the difference between the temperature of the load and that set, said solid state relay cuts one cycle of waveform from a unit cycle group including a plurality of cycles of waveform of said input AC voltage, varies the number of cycles included in the unit cycle group in response to the difference between the temperature of the load and that set, and controls the apparent frequency of the output AC voltage to be supplied to said electric heating equipment to control the temperature of the electric heating equipment.

### BRIEF DESCRIPTION OF THE DRAWINGS

Further feature of the present invention will become apparent to those skilled in the art to which the present invention relates from reading the following specification with reference to the accompanying drawings, in which:

FIG. 1 is a block diagram showing the general structure of the control apparatus in accordance with the present invention;

FIG. 2 is a graph showing one example of the waveform of the AC voltage output from the control apparatus in accordance with the present invention;

FIG. 3 is a graph showing another example of the waveform of the AC voltage output from the control apparatus in accordance with the present invention;

FIG. 4 is a graph showing further example of the waveform of the AC voltage output from the control apparatus in accordance with the present invention;

FIG. 5 is a graph showing other further example of the waveform of the AC voltage output from the control apparatus in accordance with the present invention;

FIG. 6 is a graph showing additional example of the waveform of the AC voltage output from the control apparatus in accordance with the present invention;

FIG. 7 is a graph showing further additional example of the waveform of the AC voltage output from the control apparatus in accordance with the present invention;

### DETAILED DESCRIPTION OF THE PRESENT INVENTION

An embodiment of the apparatus in accordance with the present invention will now be described with reference to the concrete example thereof with reference to the attached drawings.

It must be understood that the following description of the present invention is made on the basis of the case in which two heating equipments are to be controlled.

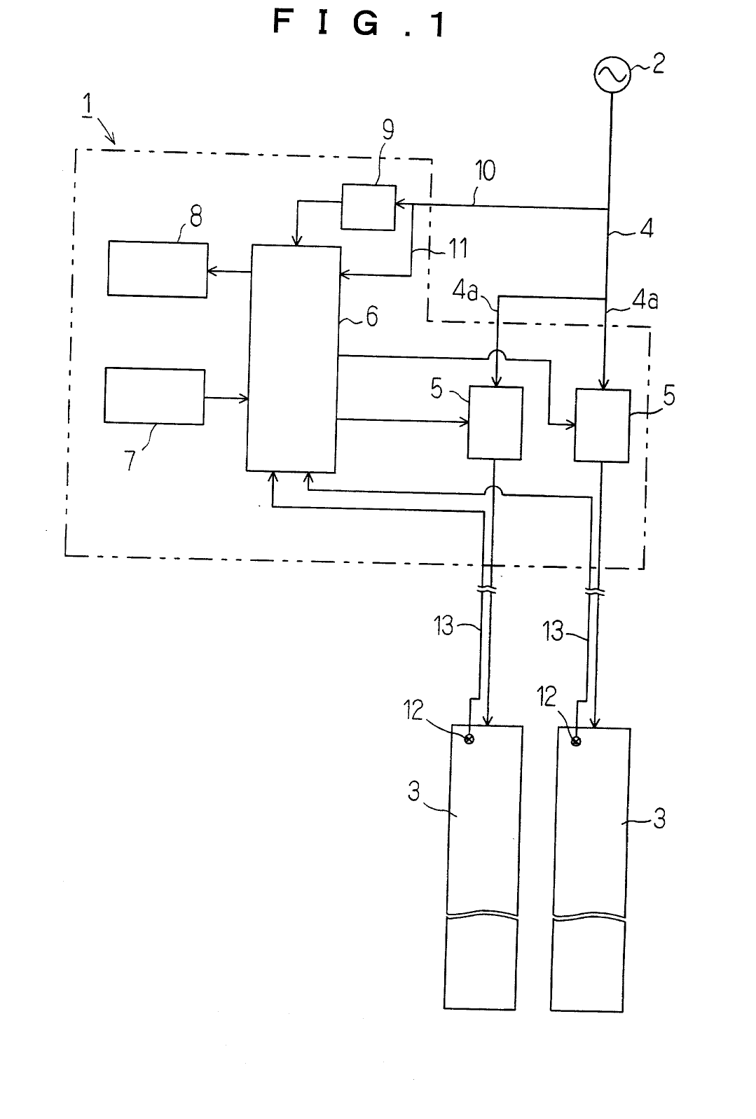

In the example as shown in FIG. 1, the reference numeral 1 is added to the control apparatus of the present invention, the reference numeral 2 is added to the AC power supply, the reference numerals 3, 3 are added to the heating equipments. The heating equipments are for example an electric heater for the road heating for melting snow on the road. The electric heater is for example a flat heater having a width of 30 cm and the length of 50 m.

The AC line 4 from the AC power supply 2 is ramified or divided into two branch AC lines 4a, 4a led to each heating equipments 3, 3 respectively. Each of the branch AC lines includes a solid state relay (referred to as SSR hereinbelow) 5 interposed between the AC line 4 and the heating equipment.

In the example as shown in FIG. 1, the reference numeral 6 is added to the central processing unit (referred to as CPU hereinbelow), the reference numeral 7 is added to the data terminal, the reference numeral 8 is added to the display, and the reference numeral 9 is added to the rectifier circuit. The data terminal 7 has an arrangement in which the temperature of the heating equipments to be achieved and the apparent frequency (to be described in detail hereinbelow) of the AC voltage output to the heating equipments can be set by variable resistors and any sort of switches included therein. The display 8 has an arrangement in which the LED's and the liquid crystal display included therein can exhibit the temperature and the apparent frequency set at the data terminal 7, and the actual temperature of the heating equipment.

The rectifier circuit 9 converts the AC voltage from the AC line 4 to the DC voltage and supplies thus obtained DC voltage to the CPU 6 for operating the same. A waveform reference line 11 has the one end connected to the analogue input port of the CPU 6 and the other end connected to the feeder line 10 extending between the AC line 4 and the rectifier circuit 9.

The CPU 6 has other analogue input ports to which the temperature signal lines 13, 13 from temperature sensors 12, 12 are connected. The CPU 6 further includes digital output ports to which the control signal lines for outputting the control signal to each SSR 5, 5 are connected.

The SSR 5 includes the TRIAC circuit which is adapted to be triggered by pulse signals or the control signals fed from CPU 6. Upon received the pulses of the control signal, the TRIAC closes the AC line until the next zero cross point of the input AC voltage waveform appeared.

In other words, CPU 6 detects the waveform of the AC voltage input through the waveform reference line 11, generates the control signals or the pulse voltages generated in synchronous with the zero cross points of the waveform of the input AC voltage, and then delivers the control signals to SSR 5.

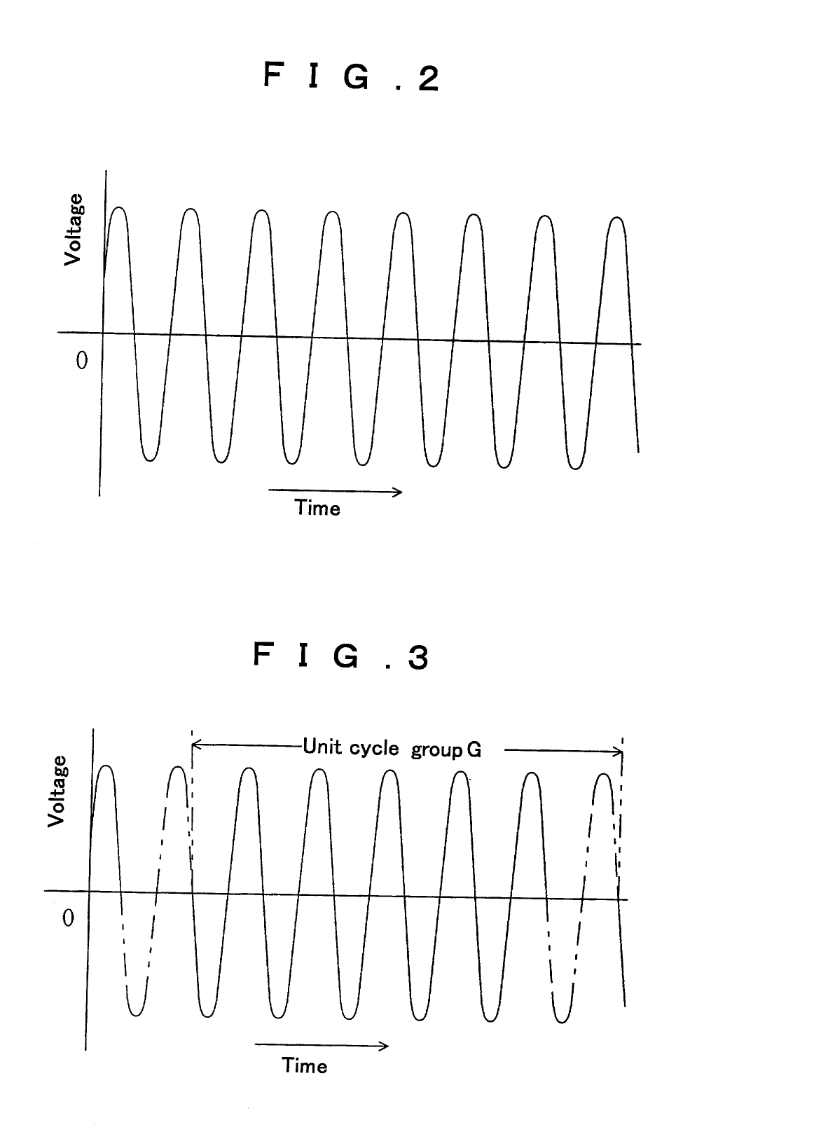

In the control apparatus of the present invention, the waveform of the input AC voltage can be cut intermittently by a unit of one cycle at SSR to output intermittently any one or more pulses of the control signal. The apparent frequency of the input AC voltage to be supplied to the electric heating equipments 3, 3 can be controlled by adjusting the interval of the waveform to be cut. The operation of the control apparatus of the present invention will now be described with reference to the concrete examples of the waveform of the AC voltage input from SSR as shown in FIGS. 2-7.

In the case that the difference between the temperature of the heating equipment 3 and that set is substantially, i.e. when it is necessary to maximize the output from the heating equipment to effect the rapid heating, the AC voltage identical in its waveform to that input is adapted to be delivered as shown in FIG. 2.

In the case that the waveform shown in FIG. 2 is delivered, the control signal supplied to SSR 5 is pulse voltages synchronous with the zero cross points of the input AC voltage. The number of pulse voltages is the same as that of the zero cross points. Naturally, both of the apparent frequency and the actual frequency are the same as the frequency of the input AC voltage.

Upon reduced the difference between the temperature of the heating equipment 3 and that set, the apparent frequency of the input AC voltage to be delivered to the electric heating equipment is controlled as shown in FIGS. 3-7. This can be effected by reducing one cycle of waveform from a unit cycle group including a plurality of cycles of waveform of the input AC voltage, and reducing the number of cycle included in the unit cycle group.

In the embodiment as shown in FIG. 3, the unit cycle group G includes 6 cycles of the waveform of the input AC voltage, and one cycle C is to be reduced from the unit group.

In the case of the waveform as shown in FIG. 3, the apparent frequency will be reduced to ⅚ of that of the input AC voltage, so that if the frequency of the input AC voltage is 50 c/s, the apparent frequency will be reduced to 41.7 c/s, and the actual voltage will be reduced to 83% of the input AC voltage.

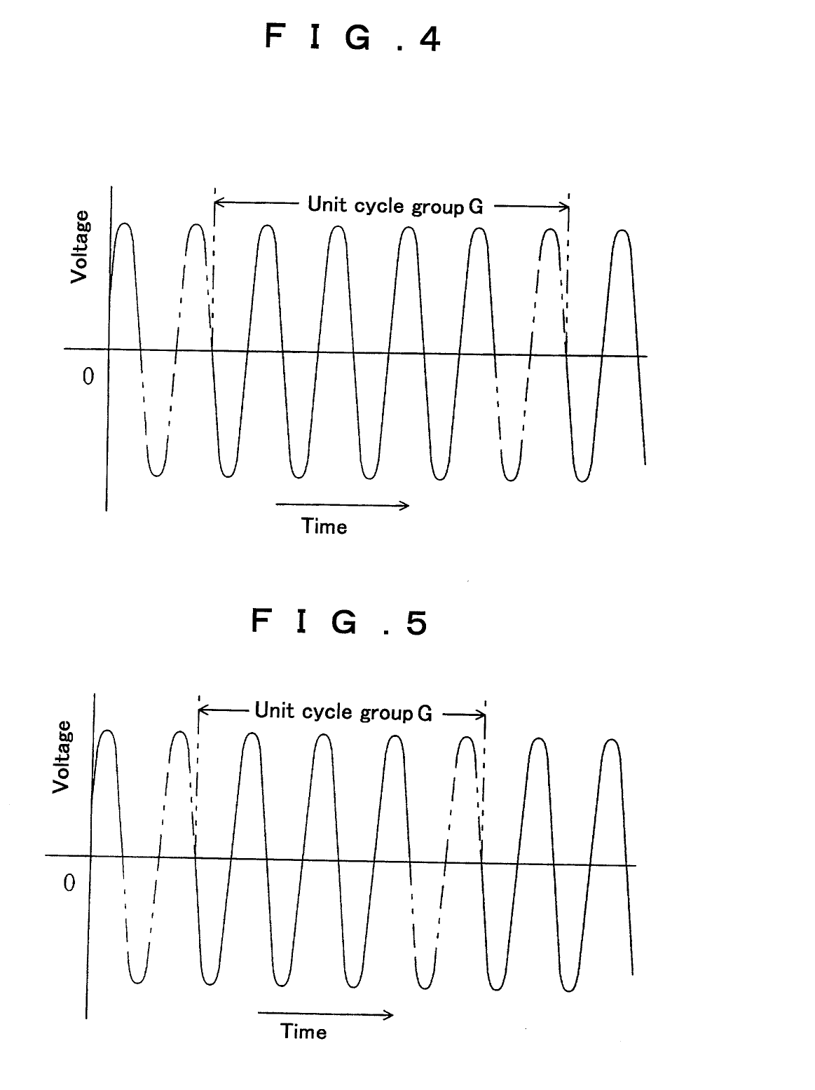

In the embodiment as shown in FIG. 4, the unit cycle group G includes 5 cycles of the waveform of the input AC voltage, and one cycle C is to be reduced from the unit group.

In the case of the waveform as shown in FIG. 4, the apparent frequency will be reduced to ⅘ of that of the input AC voltage, so that if the frequency of the input AC voltage is 50 c/s, the apparent frequency will be reduced to 40.0 c/s, and the actual voltage will be reduced to 80% of the input AC voltage.

In the embodiment as shown in FIG. 5, the unit cycle group G includes 4 cycles of the waveform of the input AC voltage, and one cycle C is to be reduced from the unit group.

In the case of the waveform as shown in FIG. 5, the apparent frequency will be reduced to ¾ of that of the input AC voltage, so that if the frequency of the input AC voltage is 50 c/s, the apparent frequency will be reduced to 37.5 c/s, and the actual voltage will be reduced to 75% of the input AC voltage.

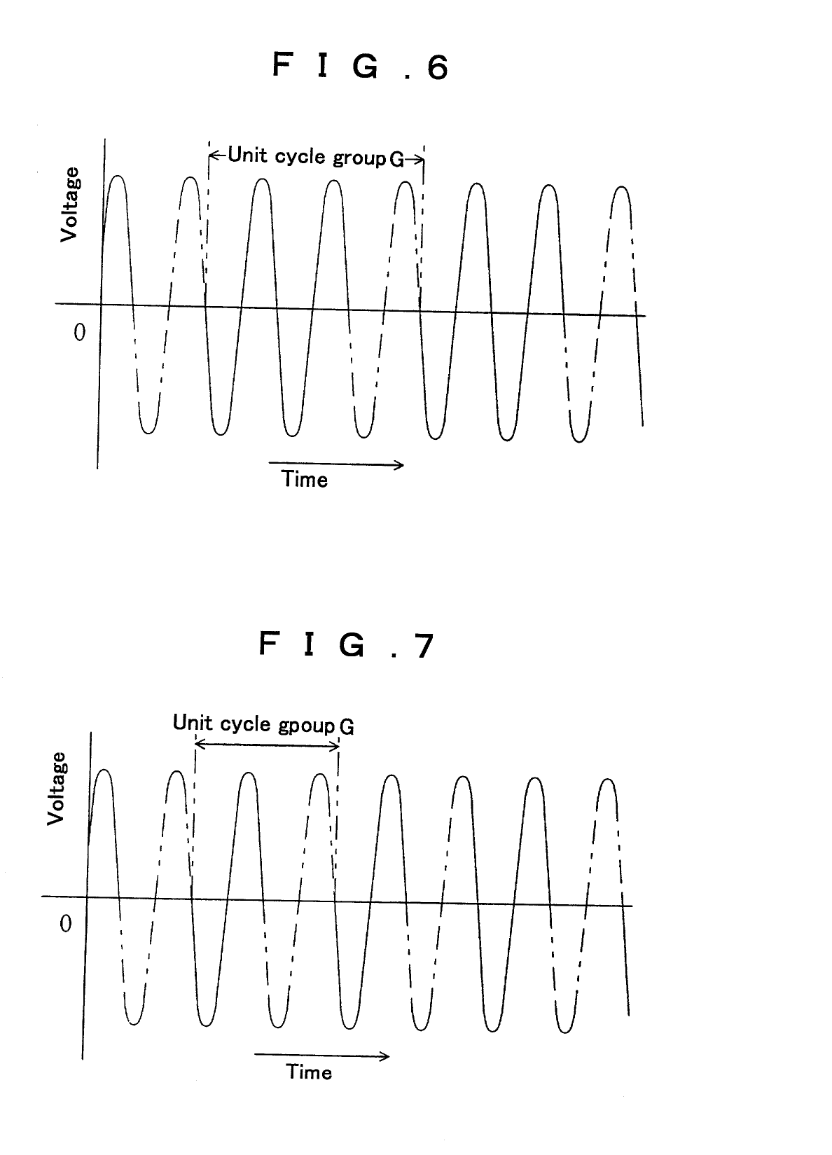

In the embodiment as shown in FIG. 6, the unit cycle group G includes 3 cycles of the waveform of the input AC voltage, and one cycle C is to be reduced from the unit group.

In the case of the waveform as shown in FIG. 6, the apparent frequency will be reduced to ⅔ of that of the input AC voltage, so that if the frequency of the input AC voltage is 50 c/s, the apparent frequency will be reduced to 33.3 c/s, and the actual voltage will be reduced to 66% of the input AC voltage.

In the embodiment as shown in FIG. 7, the unit cycle group includes 2 cycles of the waveform of the input AC voltage, and one cycle C is to be reduced from the unit group.

In the case of the waveform as shown in FIG. 7, the apparent frequency will be reduced to ½ of that of the input AC voltage, so that if the frequency of the input AC voltage is 50 c/s, the apparent frequency will be reduced to 25.0 c/s, and the actual voltage will be reduced to 50% of the input AC voltage.

Upon the control apparatus of the present invention is employed actually, each waveform of the AC voltage illustrated respectively in FIGS. 2-7 will be delivered sequentially in accordance with the reduction of the difference between the temperature of the heating equipment and that set. The switching of the waveform can be made in accordance with the program stored preliminary in CPU 6. In that program, any one of the waveform illustrated in FIGS. 2-7 is selected to be output in accordance with the corresponding difference between the temperature of the heating equipment and that set.

When the temperature of the heating equipment becomes substantially equal to that set, and is maintained constant, the waveform of the input AC voltage delivered in that time will be maintained, the variation of the load is detected from the temperature of the heating equipment, and then the AC voltage of the waveform suitable for the variation of the load will be delivered.

Although in the control apparatus of the above mentioned embodiment the AC voltage is adapted to be delivered to two heating equipments 3, 3, more or less heating equipments can also be used by increasing or decreasing the number of the ramified AC lines 4a, 4a, and SSR 5. When it is intended to vary the capacity of power to be supplied to the heating equipment, it can be effected easily by varying the capacity of the SSR.

In the embodiment as mentioned above, the waveform of the output AC voltage is adapted to be varied in accordance with the variation of the temperature of the heating equipment. However, the arrangement in which the one waveform of the output AC voltage is set at the data terminal 7 and only the AC voltage of such waveform is adapted to be delivered can also be employed.

Although only one cycle of waveform is adapted to be cut or eliminated from the unit cycle group G in the embodiment as mentioned above, apparent frequencies other than those illustrated in FIGS. 3-7 can be set by varying the combination of the number of cycles included in the unit cycle group and the number of waveform to be eliminated.

The Advantages to be Derived from the Present Invention

The control apparatus of the present invention has an arrangement for controlling the AC voltage delivered to the heating equipment by controlling the apparent frequency of the output AC voltage, not by the ON-OFF control of the output AC voltage. Thus, the control apparatus of the present invention can adjust the actual value of the output AC voltage depend on the load to be applied, can deliver necessary and sufficient power with neither too much nor too little, and can keep the temperature of the heating equipment in substantially constant nearly equal to that set preliminary. In conclusion the wastefully consumed electric power for heating can be eliminated to save the energy required.

In the apparatus in accordance with the present invention, the value of the output AC voltage and the waveform itself are left intact so that the circuit for varying the value of the voltage and that for transforming the waveform are unnecessary, i.e. the arrangement of the apparatus is relatively simple. It is therefore possible to hold down the cost for the apparatus to the minimum.

If it is intended to change the capacity of the heating equipment for the electric power, it can be achieved merely by varying the capacity of the SSR. In case the shortage of the capacity of the SSR, this can be cope with by incorporating a plurality of parallel connected SSR's into the one heating equipment to enlarge the capacity therefore.

While particular embodiments of the present invention have been illustrated and described, it should be obvious to those skilled in the art that various changes and modifications can be made without departing from the spirit and scope of the invention.

What is claimed is:

1. A temperature control apparatus for an electric heating equipment comprising:
a solid state relay included in an AC line connected between an AC power supply and the electric heating equipment; and
a central processing unit for outputting control signals to the solid state relay for switching the relay, wherein the solid state relay continuously outputs an input AC voltage fed from said AC power supply, or alternatively outputs the input AC voltage intermittently by cutting one cycle of waveform from the waveform of the input AC voltage, and wherein the temperature control of the electric heating equipment is effected by controlling the apparent frequency of the input AC voltage to be supplied to the electric heating equipment through adjusting the interval of the waveform.

2. A temperature control apparatus for an electric heating equipment comprising:
a solid state relay included in an AC line connected between an AC power supply and the electric heating equipment; and
a central processing unit to which connected a temperature signal line from a temperature sensor or sensors arranged over the electric heating equipment, said central processing unit outputs control signals to the solid state relay for the switching operation of the solid state relay on the basis of the temperature of a load of the electric heating equipment detected by the temperature sensor, wherein provided that the difference between the temperature of the load and that set on the central processing unit is substantially, said solid state relay outputs an AC voltage identical in its waveform with that fed from said AC power supply, whereas upon reduced the difference between the temperature of the load and that set, said solid state relay cuts one cycle of waveform from a unit cycle group including a plurality of cycles of waveform of said input AC voltage, varies the number of cycles included in the unit cycle group in response to the difference between the temperature of the load and that set, and controls the apparent frequency of the output AC voltage to be supplied to said electric heating equipment to control the temperature of the electric heating equipment.
